(19) United States
(12) Patent Application Publication
(10) Pub. No.: US 2020/0178516 A1
(43) Pub. Date: Jun. 11, 2020

(54) BIRD PROTECTION APPARATUS

(71) Applicant: Douglas A. Gore, Saint Amant, LA (US)

(72) Inventor: Douglas A. Gore, Saint Amant, LA (US)

(21) Appl. No.: 16/211,162

(22) Filed: Dec. 5, 2018

(51) Int. Cl. A01M 29/32; F16M 13/02

(52) U.S. Cl. CPC A01M 29/32; F16M 13/02

(57) ABSTRACT

The bird protection apparatus of the present invention provides an improved way to deter bird and animals from perching or resting on structures by physically blocking them from landing upon the structure. Furthermore, the bird protection apparatus is a low-profile and minimalistic design made to not distract the viewer from viewing the key attributes of the structure. The bird protection apparatus includes a main body, a vertical member, a main cross member, and an attachment assembly. In some embodiments, the bird protection apparatus comprises a plurality of main cross members and secondary cross members.

### RELATED APPLICATION

N/A

### BACKGROUND

### 1. Field of the Invention

The present invention is directed towards a bird protection apparatus for protecting a structure from damage from birds and animals

### 2. Description of Related Art

As the human population of the world increases, humans are quickly developing more commercial structures, homes and roads. This increase in development has caused more natural environments and rural areas to be commercially developed. When natural habit for native animals is greatly reduced by expanding human developments, the interaction between humans and native animals increases greatly. Commonly, preventive measures are taken by humans to decrease the risk of personal property becoming damaged by native animals. Birds can be the most detrimental to homes and places of business when allowed to perch or rest upon structures attached to or surrounding homes and places of business. Commonly the feces of native birds and animals can drive away business or alter the outward appearance of a home or place of business. Traditionally overhangs, light posts, and doorways have been retrofitted with spikes and netting to deter birds and other animals from perching or resting upon the overhangs. These spikes and nets are often non-appealing to the human eye and negatively change the appearance of places of business.

Further, traditional spikes and netting require many hours of preparation and custom fitting processes to work properly. Often traditional spikes and netting require extra tools and cause unnecessary damage to the structure when being assembled. Consequently, an improved and less-visible way to deter bird and animals from perching and resting upon structures requiring minimal preparation, no custom fitting processes, no extra tools, and causing no installation damage to the existing structure is needed.

### SUMMARY

The bird protection apparatus of the present invention solves the problems described above by providing an improved way to deter bird and animals from perching or resting on structures by physically blocking them from landing upon the structure. Furthermore, the bird protection apparatus is a low-profile and minimalistic design made to not distract the viewer from viewing the key attributes of the structure. The key attributes of the structures being protected by the bird protection apparatus are, for example, maintaining a clean place of business and clearly conveying a message to the viewer.

Another object of the present invention is to reduce the installation time and unnecessary installation damage caused in the process of mounting traditional spikes and nets by providing a simple attachment assembly.

In order to do so a bird protection apparatus is provided, comprising a main body having a top side and a bottom side; wherein the bottom side of the main body is adjoined to the structure; a vertical member joined to the top side of the main body; wherein the vertical member protrudes perpendicularly from the top side of the main body; a main cross member, joined to the vertical member; wherein the main cross member spans at least 50% of a length of the structure; wherein the main cross member prevents the birds and the animals from resting upon the structure; and an attachment assembly, joined to the bottom side of the main body; wherein the attachment assembly secures the bird protection apparatus to the structure.

### BRIEF DESCRIPTION OF THE FIGURES

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows an exemplary isometric perspective view of one embodiment of bird protection apparatus.

FIG. 2 shows an exemplary left perspective view of one embodiment of bird protection apparatus.

FIG. 3 shows an exemplary front perspective view of one embodiment of bird protection apparatus.

FIG. 4 shows an exemplary isometric perspective view of one embodiment of bird protection apparatus.

FIG. 5 shows an exemplary left perspective view of one embodiment of bird protection apparatus.

FIG. 6 shows an exemplary front perspective view of one embodiment of bird protection apparatus.

FIG. 7 shows an exemplary isometric perspective view of one embodiment of bird protection apparatus having a plurality of cross members.

FIG. 8 shows an exemplary isometric perspective view of one embodiment of bird protection apparatus having a plurality of cross members.

FIG. 9 shows an exemplary isometric perspective view of one embodiment of bird protection apparatus mounted to an exemplary structure.

FIG. 10 shows an exemplary isometric perspective view of one embodiment of bird protection apparatus mounted to an exemplary structure.

### DETAILED DESCRIPTION OF CERTAIN EMBODIMENTS

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

Unless otherwise defined, all technical terms used herein have the same meaning as commonly understood by one of ordinary skill in the art to which this disclosure belongs. As used herein, the singular forms “a,” “an,” and “the” include plural references unless the context clearly dictates otherwise. Any reference to “or” herein is intended to encompass “and/or” unless otherwise stated. As used herein, the term “about” refers to an amount that is near the stated amount by about 0%, 5%, or 10%, including increments therein.

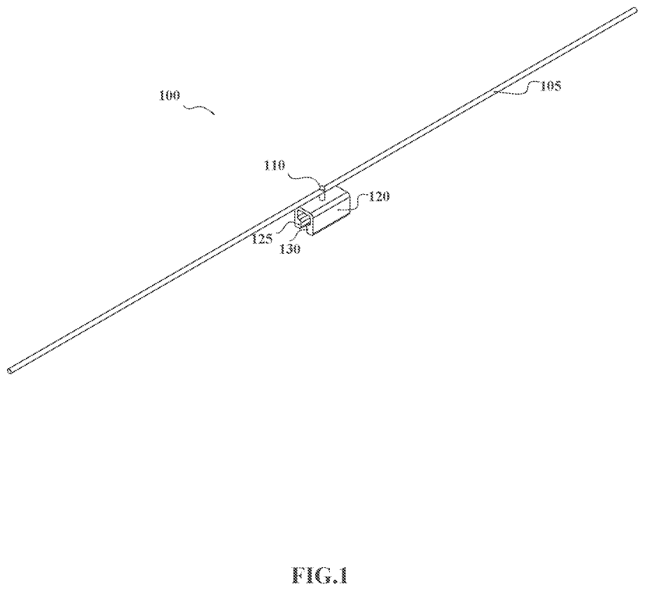

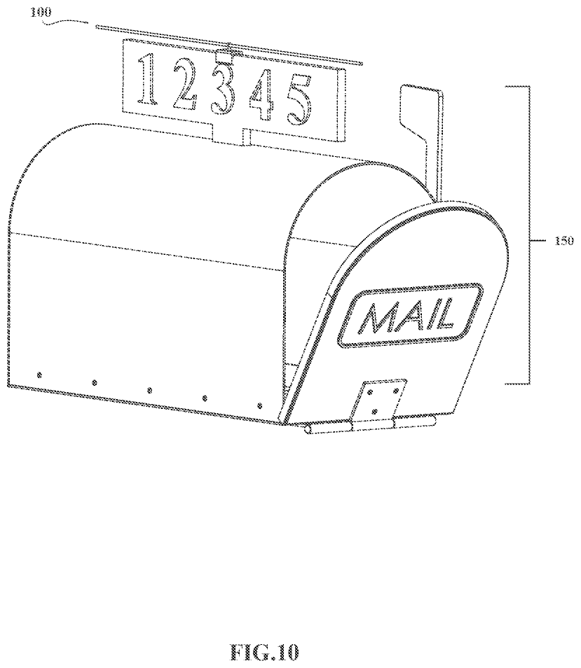

FIG. 1 shows an exemplary isometric perspective view of one embodiment of bird protection apparatus 100. In one embodiment, the bird protection apparatus comprises a main body 120 having a top side and a bottom side, a vertical member 110, and a main cross member 105. The vertical member protruding perpendicularly from and adjoined to the top side of the main body. The main cross member in the current embodiment is adjoined to the vertical member and has a length that spans the majority of a structure being protecting by the bird protection apparatus. In the current exemplary embodiment, the attachment assembly is shown as a plastic clip having a left clip 125 and a right clip 130. The left clip and the right clip, in the current embodiment rely on the elasticity of the plastic material, used to make the main body of the bird protection apparatus, allowing the main body to deflect and hold the bird protection apparatus to structure 150. For example, the structure being protecting can be an address sign of a mailbox, as shown in FIG. 10. In other embodiments, the attachment assembly is at least one member of an attachment set consisting of: a plastic clip, a spring clip, an adhesive article 135, and a mounting bracket. In some embodiments, the bird protection apparatus is made of at least one material of a material set consisting of: a wood material, a plastic material, a metal material, a rubber material, a polymer material, a fiberglass material, and a composite material. The plastic material used to make the bird protection apparatus can be one of the following plastic material types, by way of non-limiting example, a polyethylene terephthalate (PETE or PET) plastic, a polyethylene (PE) plastic, a polyvinyl chloride (PVC) plastic, a polypropylene (PP) plastic, a polystyrene (PS) plastic, a polylactic acid (PLA) plastic, a thermoplastic, a polycarbonate (PC) plastic, an acrylic (PMMA) plastic, a acetal plastic, a nylon plastic, and an acrylonitrile butadiene styrene (ABS) plastic.

The bird protection apparatus can be made by at least one of the following processes, by way of non-limiting example, including: a 3D printing process, an injection moldings process, a CNC milling process, a rotational mold forming process, a blow molding process, a compression molding process, and a vacuum molding process.

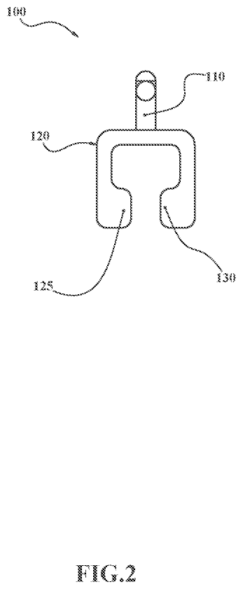

FIG. 2 shows an exemplary left perspective view of one embodiment of bird protection apparatus 100. FIG. 2 illustrates in closer detail the exemplary left clip 125 and the exemplary right clip 130 of main body 120 of the bird protection device. The current exemplary embodiment is designed to allow the left clip and the right clip to snap over an address sign of a mailbox or any other style of panel sign.

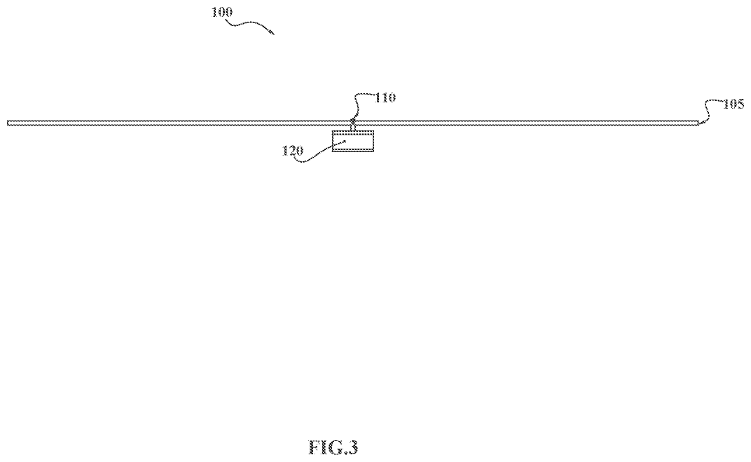

FIG. 3 shows an exemplary front perspective view of one embodiment of bird protection apparatus 100. In the current exemplary embodiment, main cross member 105, secondary cross member 115, and vertical member 110 are shown as circular rods. In some embodiments, the cross-sectional shape of the main cross member, the secondary cross member, and the vertical member can be made as, by way of non-limiting example, a honeycomb shape, a diamond shape a square, a triangle, a rectangle, an octagon and an oval.

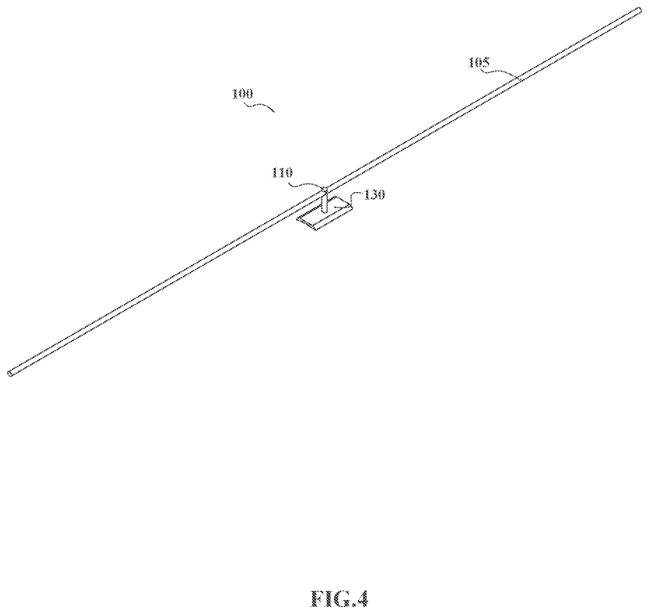

FIG. 4 shows an exemplary isometric perspective view of one embodiment of bird protection apparatus 100. In the embodiment illustrated in FIG. 4, the bottom side of the main body is inwardly concave to match the arch of structure 150 being protecting by the bird protection apparatus 100.

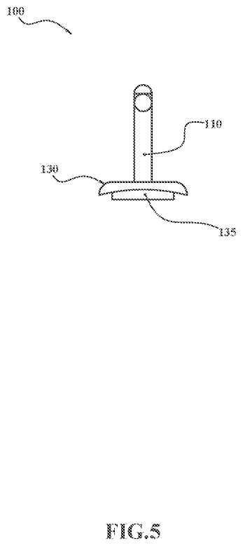

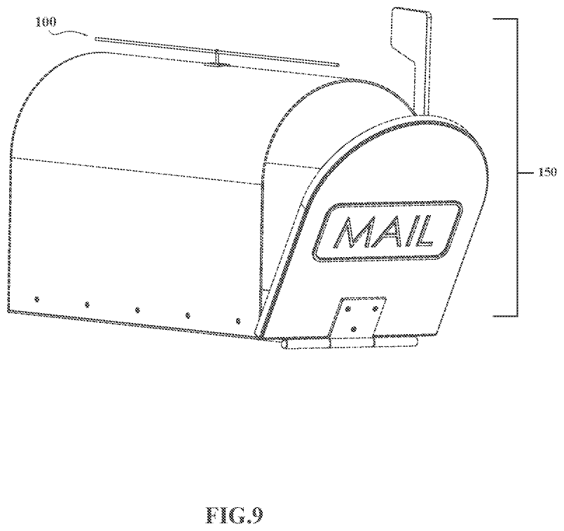

FIG. 5 shows an exemplary left perspective view of one embodiment of bird protection apparatus 100. An adhesive article 135 is shown adjoined to the bottom side of the main body of the bird protection apparatus. The adhesive article secures the bird protection apparatus to the structure being protecting by the bird protection apparatus. For example, the arched top of a mailbox is a common structure for birds and animals to perch or rest upon. This embodiment, as shown in FIGS. 4-6 having a concave bottom side of the main body can be seen in FIG. 9 adhered to a non-claimed and exemplary mailbox.

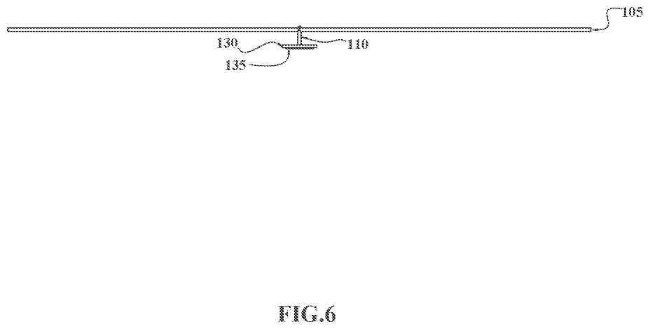

FIG. 6 shows an exemplary front perspective view of one embodiment of bird protection apparatus 100 having an adhesive article 135 on the bottom side of main body 120.

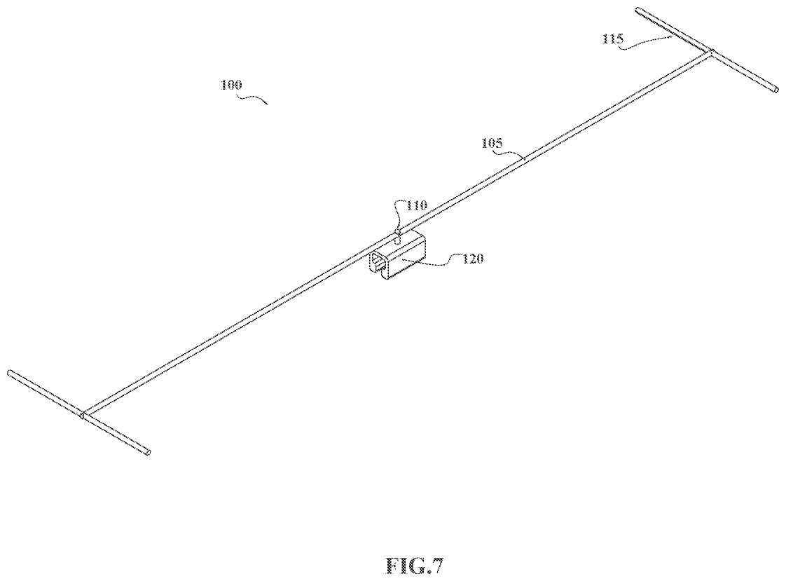

FIG. 7 shows an exemplary isometric perspective view of one embodiment of bird protection apparatus 100 having a plurality of secondary cross members 115. In some embodiments, the bird protection apparatus further comprises a secondary cross member 115, wherein the secondary cross member is joined to the main cross member 105 and aligns perpendicularly to main cross member 105. In some embodiments, it is necessary to have a plurality of main cross members to broadly cover the structure the bird protection apparatus is mounted upon.

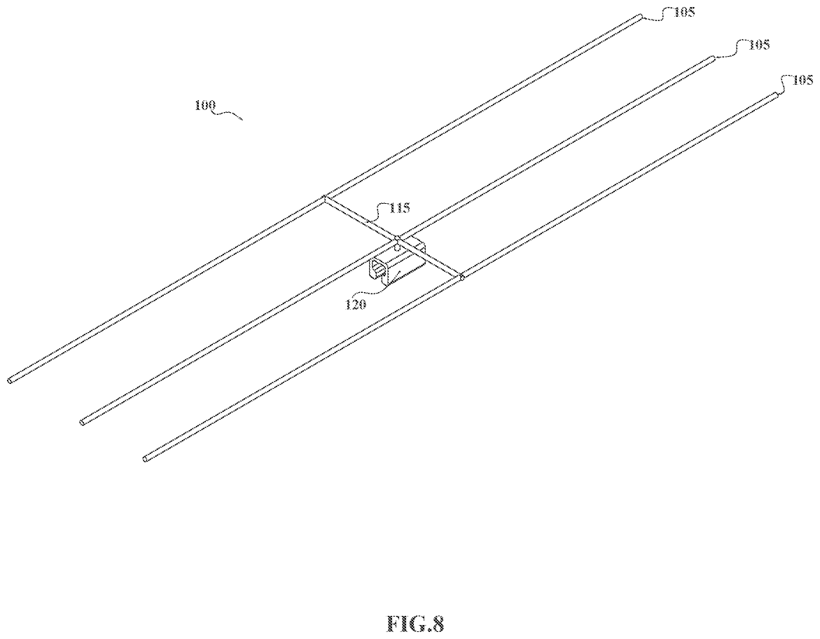

FIG. 8 shows an exemplary isometric perspective view of one embodiment of the bird protection apparatus 100 having a plurality of main cross members 105 and one secondary cross member 115. In some embodiments, it is necessary to have a plurality of secondary cross members 115 to broadly cover the structure the bird protection apparatus is mounted upon.

FIG. 9 shows an exemplary isometric perspective view of one embodiment of bird protection apparatus 100 mounted to an exemplary structure 150. In this exemplary embodiment, the structure is a mailbox having an arched top.

FIG. 10 shows an exemplary isometric perspective view of one embodiment of bird protection apparatus mounted to an exemplary structure 150. In this exemplary embodiment, the structure is a mailbox having an arched top and a flat address sign.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

Any element in a claim that does not explicitly state “means for” performing a specified function, or “step for” performing a specified function, is not to be interpreted as a “means” or “step” clause as specified in 35 U.S.C. § 112, 6. In particular, any use of “step of” in the claims is not intended to invoke the provision of 35 U.S.C. § 112, 6.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A bird protection apparatus for protecting a structure from damage from birds, the bird protection apparatus comprising:
a main body having a top side and a bottom side, wherein the bottom side of the main body is adjoined to the structure;
a vertical member joined to the top side of the main body, wherein the vertical member protrudes perpendicularly from the top side of the main body;
a main cross member joined to the vertical member, wherein the main cross member spans at least 50% of a length of the structure, the cross member preventing the birds and the animals from resting upon the structure; and,
an attachment assembly joined to the bottom side of the main body, wherein the attachment assembly secures the bird protection apparatus to the structure.

2. The bird protection apparatus of claim 1, wherein the attachment assembly is at least one member of an attachment set consisting of: a plastic clip, a spring clip, an adhesive article, and a mounting bracket.

3. The bird protection apparatus of claim 2, wherein the mounting bracket of the attachment assembly further comprises at least one hole for a fastener to pass through.

4. The bird protection apparatus of claim 1, wherein the bird protection apparatus is made of at least material of a material set consisting of: a wood material, a plastic material, a metal material, a rubber material, a polymer material, a fiberglass material, and a composite material.

5. The bird protection apparatus of claim 1, further comprising a plurality of main cross members.

6. The bird protection apparatus of claim 1, further comprising a secondary cross member, wherein the secondary cross member is joined to the main cross member and aligns perpendicularly to the main cross member.

7. The bird protection apparatus of claim 6, further comprising a plurality of secondary cross members.
